(19) United States
(12) Patent Application Publication
(10) Pub. No.: US 2012/0223193 A1
(43) Pub. Date: Sep. 6, 2012

(54) SUPPORT STAND APPARATUS AND METHODS OF USE

(75) Inventor: Jesse Trevor Hurley, Cottage Grove, WI (US)

(73) Assignee: MASTERPIECE OUTDOORS INC., Cottage Grove, WI (US)

(21) Appl. No.: 13/406,598

(22) Filed: Feb. 28, 2012

Related U.S. Application Data
(60) Provisional application No. 61/464,367, filed on Mar. 4, 2011.

(51) Int. Cl. F16M 11/20

(52) U.S. Cl. 248/163.1

(57) ABSTRACT

A support stand having a stand base, mounting a tool support. At least first and second stand base legs extend parallel to each other below intermediate locations of the legs, and converge on each other above the intermediate locations. The parallel portions are readily pushed into soil/ground using an adult's weight. A support leg bracket joins a support leg to the top of the stand base, and accommodates adjusting the support leg for height, and rotation about a vertical axis. A first tool bracket on the support leg has upright and angular flanges which, collectively, enable rotation of the angular flange about a generally horizontal axis. A second tool bracket can be mounted to the support leg. The second tool bracket can rotate about the support leg and has second upright angular flanges which, collectively, enable rotation of the second angular flange about a second generally horizontal axis.

### CROSS REFERENCES TO RELATED APPLICATIONS

This Application is a Non-Provisional of U.S. Provisional Patent Application Ser. No. 61/464,367, filed Mar. 4, 2011, the preceding application being herein incorporated by reference in its entirety.

### BACKGROUND OF THE INVENTION

This invention relates to portable tool support stands. Specifically, this invention relates to supporting cameras and/or other tools in locations where the ground surface is uneven, soft, or otherwise not conducive to staple support of a camera or other tool while unattended over an extended period of time, using a conventional tri-pod, and wherein the tool so supported needs to be pointed in literally any direction about both vertical and/or horizontal axes.

This invention specifically relates to support of motion cameras in wilderness environments, where the user leaves the camera unattended, mounted to a support stand, for several days or weeks at a time. Thus, the stability of the support stand must take into account all weather and other natural forces typically encountered at the use location.

Thus, it would be desirable to provide a support stand which can be transported to a remote wilderness use location by a single adult person.

Further, it would be desirable to provide a support stand which can be manually installed, fixedly stable, in a use location, using only the user's manual capacities.

In addition, it would be desirable to provide one or more driver connectors on the support stand which are readily employed to apply the user's weight to drive base legs of the support stand into the native soil at the use location.

Further, it would be desirable to provide at least one vertical axis of orientation of a tool support implement and at least one horizontal axis of orientation of such tool implement.

Yet further, it would be desirable to provide such support stand in combination with a second tool support implement whereby at least first and second tools/cameras can be mounted, independently, to the support stand.

Still further, it would be desirable to provide such multiple tool/camera mounts wherein the respective cameras can be separately directed in different directions.

It is yet further desirable to provide such support stand where a tool support leg can be extended and/or retracted relative to a support base thereby to expand/retract the height of the support stand for use and/or transport.

These and other needs are alleviated, or at least attenuated, or partially or completely satisfied, by the novel products and methods of the invention.

### SUMMARY OF THE INVENTION

This invention provides a support stand having a stand base and a tool support mounted to the stand base. The stand base has at least first and second elongate and narrow base legs which extend parallel to each other below intermediate locations along the lengths of the legs, and converge toward each other above the intermediate locations, to a joinder locus. The parallel portions of the legs are sufficiently narrow that the lower portions of the base legs are readily pushed into natural soil/ground using the weight of a single adult. At the top of the stand base, a support leg bracket joins a support leg to the stand base, where the support leg bracket accommodates adjusting the support leg both for vertical height and for 360 degrees rotation about the vertical axis of the support leg, whereby a device attached to the support leg can be so adjusted. A first, or only, tool bracket on the support leg has an upright flange and an angular flange which, collectively, enable 360 degree rotation of the angular flange, and thus a device/tool mounted on the angular flange, 360 degrees of rotation, about a generally horizontal axis. A second tool bracket can be mounted to the support leg below the first tool bracket. The second tool bracket can rotate 360 degrees about the support leg. The second tool bracket has a second upright flange and a second angular flange which, collectively, enable 360 degree rotation of the second angular flange, and thus a device/tool mounted on the second angular flange, 360 degrees of rotation, about a second generally horizontal axis.

In a first family of embodiments, the invention comprehends a tool stand, comprising a stand base, the stand base having a top and a bottom, and a height between the top and the bottom, the stand base comprising first, second, and third elongate base legs in fixed spatial relationship to each other, the first, second, and third base legs having respective first, second, and third lower ends, respective first, second, and third upper ends, and respective first, second, and third intermediate loci between the respective upper and lower ends, the first, second, and third base legs being parallel to each other between the intermediate loci and the lower ends of the base legs, and converging toward each other above the intermediate loci; and a tool support, having a tool support top and a tool support bottom, and a tool support height between the tool support top and the tool support bottom, the tool support being adapted to be mounted to the stand base.

In some embodiments, the first and second base legs join the third base leg at first and second fixed joinder loci at one or more upper portions of the support stand, above a mid-point of the height of the stand base.

In some embodiments, an extension portion of the stand base extends upwardly above the joinder loci and comprises an extension of at least one of the first, second, and third base legs.

In some embodiments, an extension portion of the stand base extends upwardly above the joinder loci, the tool support comprising a tool support leg mounted to the extension portion of the stand base by a support leg bracket, the tool support leg having a top and a bottom, and being vertically adjustable by enabled sliding and releasable fixation of the tool support leg controlled through the support leg bracket.

In some embodiments, the support leg bracket comprises a first laterally extending upper leg mounted to the extension portion of the stand base at a relatively upper location and having a first remote end remote from the extension portion, a second laterally extending lower leg mounted to the extension portion of the stand base at a relatively lower location and having a second remote end remote from the extension portion, and an upright bight leg remote from the extension portion and connected to both of the first and second laterally extending legs at the respective remote ends thereof, wherein the support bracket defines a generally “U”-shaped bracket having first and second lateral legs and an upright bight leg, a space being defined between the first and second lateral legs and on one side by the bight leg.

In some embodiments, first and second apertures extend coaxially through the first and second lateral legs intermediate the extension portion and the respective remote ends of the lateral legs, a third aperture extending through the bight leg intermediate the remote ends of the first and second lateral legs, the tool support leg extending through the first and second apertures and across the space between the first and second lateral legs, and thus being spaced from the extension portion of the stand base, a set screw threadedly extending through the third aperture and releasably securing an elevation of the extension portion relative to the stand base.

In some embodiments, the first and second lateral legs have respective first and second thicknesses, and first and second bushings extend through the first and second apertures between side walls of the first and second apertures and the tool support leg, and across portions of the space between the first and second apertures, each by distances at least as great as the thickness of the respective first or second lateral leg as penetrated by the respective first and second apertures.

In some embodiments, the tool support leg is laterally spaced from the first and second joinder loci, with open space between the tool support leg and the stand base.

In some embodiments, each base leg has a top and a bottom, and each base leg changes direction at least once between the respective top and the respective bottom of a given base leg.

In some embodiments, each base leg has a top and a bottom, a driver connector extending between, and being rigidly and fixedly mounted to, at least two of the base legs, and thereby providing at least one rigidly and fixedly mounted driver connector at a height of no more than 10 inches above the bottoms of the respective base legs.

In some embodiments, a first driver connector extends between, and is mounted to, the first and second base legs, a second driver connector extending between, and being mounted to, the second and third base legs, and a third driver connector extending between, and being mounted to, the third and first base legs.

In some embodiments, the stand base has a top and a bottom, and a mid-point halfway between the top and the bottom, and a driver connector mounted to, and extending laterally from, opposing sides of the stand base above the midpoint.

In some embodiments, the tool stand further comprises a tool bracket mounted to the tool support leg at the top of the tool support leg.

In some embodiments, the tool bracket comprises a transversely extending flange, and an angular flange releasably and rotatably mounted to the transversely extending flange.

In some embodiments, the tool stand further comprises a second tool bracket releasably and rotatably mounted to the tool support, adjustable vertically along the heights of the tool support between the tool bracket and the stand base.

In some embodiments, the second tool support bracket is mounted for 360 degrees rotation about a vertical axis by either or both of (i) rotation of the second tool support bracket about the tool support, and (ii) rotation of the tool support about the stand base.

In some embodiments, the second tool support bracket comprises mounting structure mounting the tool support bracket to the tool support, a mounting plate extending transversely from the mounting structures, and a device plate releasably and rotatably mounted to the mounting plate.

In some embodiments, the upper portions of at least first and second ones of the base legs, above the intermediate portions, collectively define a sheet material wrap having a convergingly narrowing cross-section extending toward the joinder locus.

In a second family of embodiments, the invention comprehends a tool stand, comprising a stand base, the stand base having a top and a bottom, and a height between the top and the bottom, the stand base comprising first and second base legs, the first and second base legs having respective first and second lower ends, respective first and second upper ends, and first and second intermediate loci between the respective upper and lower ends, the first and second base legs, in a use configuration, being parallel to each other between the intermediate loci and the lower ends of the base legs and converging toward each other above the intermediate loci, and being joined to each other at fixed locations on the respective base legs in the respective upper ends thereof, a driver connector connecting the first and second base legs to each other and thereby providing at least one driver connector at a height above the bottoms of the respective base legs; and a tool support mounted to the stand base.

In some embodiments, the driver connector is no more than 10 inches above the bottom of the respective base leg, and the lower ends of the base legs are spaced from each other in such use orientation by no more than about 15 inches.

In some embodiments, the first and second base legs join each other above a mid-point of the height of the stand base, at a joinder locus.

In some embodiments, one of the first and second base legs is straight between the respective upper and lower ends of the respective base leg, and wherein the stand base is limited to no more than two base legs.

In some embodiments, an extension portion of the stand base extends upwardly above the joinder locus, the tool support comprising a tool support leg mounted to the extension portion of the stand base by a tool support bracket, the tool support leg being vertically adjustable by enabled sliding and releasable fixation of the tool support leg, controlled through the support leg bracket.

In a third family of embodiments the invention comprehends a tool stand, comprising a stand base, the stand base having a top and a bottom, and a height between the top and the bottom, the stand base comprising first and second base legs, the first and second base legs having respective first and second lower ends, respective first and second upper ends, and first and second intermediate loci between the respective upper and lower ends, the first and second base legs being parallel to each other between the intermediate loci and the lower ends of the base legs and converging toward each other at converging portions thereof above the intermediate loci, and a driver connector extending between the first and second legs, and connecting the first and second base legs to each other, at locations on the converging portions of the base legs above the intermediate loci; and a tool support mounted to the stand base.

In a fourth family of embodiments, the invention comprehends a mounting bracket, comprising an upper lateral leg having first and second ends; a lower lateral leg having third and fourth ends, respectively aligned with the first and second ends of the upper lateral leg; a bight leg rigidly connected to both of the second and fourth ends of the first and second lateral legs such that the upper lateral leg overlies the lower lateral leg when the bight leg is in a vertical orientation, thereby defining a bracket space between the upper and lower lateral legs, and bounded on one side by the bight leg; first and second apertures extending coaxially through the upper and lower lateral legs intermediate the respective ends of the upper and lower lateral legs; a third threaded aperture extending through the bight leg intermediate opposing ends of the bight leg; a set screw extending through the third aperture and into the bracket space; a mounting plate extending transversely from the bight leg and away from the upper and lower lateral legs such that the mounting plate is generally equidistant from both of the upper and lower lateral legs; and a device plate releasably mounted to the mounting plate so as to be rotatable with respect to the mounting plate, a portion of the device plate extending transverse to the mounting plate.

In some embodiments, the device plate extends in a direction generally in common with direction of extension of the lateral legs away from the bight leg.

In some embodiments, the invention comprehends a tool stand, comprising a stand base; a tool support, the tool support being mounted to the stand base; and a such mounting bracket releasably mounted to the tool support so as to accommodate 360 degree rotation of the mounting bracket with respect to the stand base. In some embodiments, the mounting bracket is mounted to the tool support so as to accommodate 360 degree rotation of the mounting bracket with respect to the tool support.

In some embodiments, the tool stand further comprises a camera releasably mounted to the device plate.

In a fifth family of embodiments, the invention comprehends a mounted assembly, comprising a generally U-shaped bracket comprising upper and lower lateral legs each having respective opposing ends, a bight leg rigidly connecting the upper and lower lateral legs to each other with the upper lateral leg overlying the lower lateral leg, first and second apertures extending coaxially through the upper and lower lateral legs intermediate the respective opposing ends thereof; a mounting plate affixed to, and extending transversely from, the bight leg and away from the upper and lower lateral legs such that the mounting plate is generally equidistant from both of the upper and lower lateral legs; a device plate releasably mounted to the mounting plate so as to be rotatable with respect to the mounting plate, a mounting panel of the device plate extending transverse to the mounting plate; and a camera mounted to the mounting panel and thereby being supported by the mounting bracket.

In some embodiments, the invention comprehends a tool stand, comprising a stand base; and a tool support, mounted to the stand base, a mounted assembly comprising a generally U-shaped such bracket, a such mounting plate, a such device plate, and a such camera being mounted to, and supported by, the tool stand.

In some embodiments, the supported assembly comprises a such tool stand, including the stand base, the tool support, and the mounted assembly, and further comprises a second bracket mounted to the tool support, the second bracket comprising a second mounting plate mounted to the tool support, and a second device plate releasably mounted to the second mounting plate so as to be rotatable with respect to the second mounting plate, a mounting panel of the device plate extending transverse to the second mounting plate, a second camera being mounted to the second mounting panel and thereby supported by the second mounting bracket.

In some embodiments, the tool support can be rotated 360 degrees with respect to the stand base, thereby to rotate the second camera 360 degrees with respect to the stand base. In some embodiments, the generally U-shaped bracket can be rotated 360 degrees with respect to the tool support.

In a sixth family of embodiments, the invention comprehends a method of emplacing a camera, comprising emplacing a camera support stand at a selected location, such camera support stand assembly comprising a stand base, the stand base comprising first and second base legs in fixed spatial relationship to each other, the first and second base legs having respective first and second lower ends, respective first and second upper ends, and first and second intermediate loci between the respective upper and lower ends, the first and second legs being parallel to each other at the lower ends of the base legs, below the intermediate loci and converging toward each other above the intermediate loci, a driver connector rigidly and fixedly connecting the first and second base legs to each other at a height above the bottoms of the respective base legs, the method comprising positioning the camera support stand assembly at the selected location on a natural soil surface with the lower ends of the legs pointing downwardly; manually pushing on the driver connector with a single adult person's weight and thereby driving the base legs into natural soil far enough that the camera support stand can reliably support itself in a routine natural-weather environment for an extended period of time while unattended; and mounting a camera on the camera support stand assembly.

In some embodiments, the selected location comprises a first selected location, the method further comprises manually pulling the support stand out of the natural soil, moving the support stand to a second selected location displaced from the first selected location, again on a natural soil surface, and again manually pushing on the driver connector with a single adult person's weight and thereby again manually driving the base legs into natural soil such that the camera support stand can again reliably support itself in a typically natural-weather environment.

In some embodiments, the method includes monitoring activities at multiple locations using a single camera, the method comprising emplacing such camera at a first such selected location, and collecting a first set of images while the camera is located at the first selected location, manually pulling the camera support stand out of the natural soil at the first selected location, moving the camera support stand to a second selected location over natural soil and emplacing such camera at the second selected location by again manually pushing on the driver connector with a single adult person's weight and thereby again manually driving the base legs into natural soil and thereby emplacing the camera at the second selected location, and collecting a second set of images while the camera is located at the second selected location.

### BRIEF DESCRIPTION OF THE DRAWINGS

FIG. 1 is a full-height pictorial view of a support stand of the invention.

FIG. 2 is a pictorial view of the stand base of the support stand of FIG. 1, with a second embodiment being shown in dashed outline.

FIG. 2A is a pictorial view as in FIG. 2 wherein upper portions of the base legs have been replaced with an upwardly converging sheet material wrap.

FIG. 3 is a pictorial view of the tool support portion of the support stand of FIG. 1, including the support leg bracket, the upper mounting bracket, and the second/intermediate mounting bracket.

FIG. 4 is an enlarged view of the upper portion of the tool support, including the upper mounting bracket detail.

FIG. 5 is an enlarged pictorial view of the intermediate mounting bracket mounted on the tool support.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

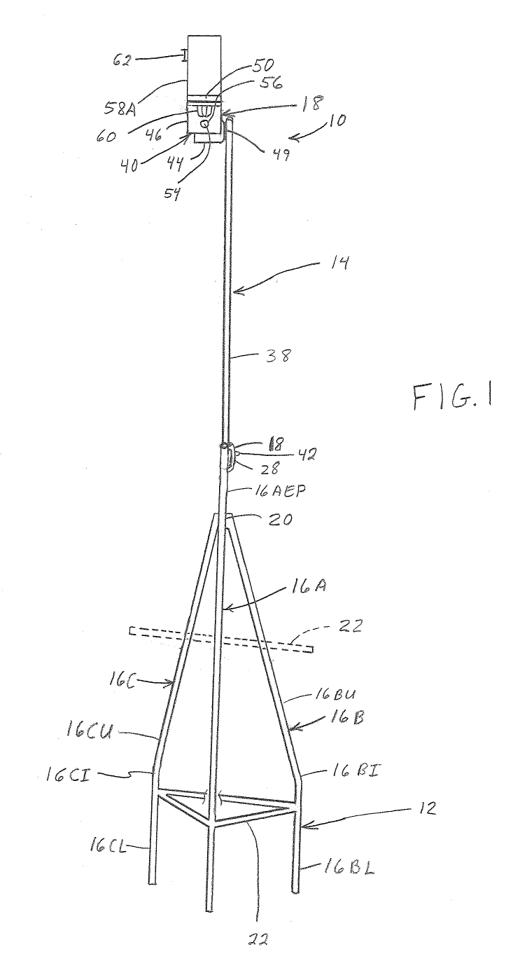

FIG. 1 generally illustrates the support stands of the invention. In general, a tool support stand 10 includes a stand base 12 and a tool support 14 mounted to the stand base. As illustrated in FIG. 1, stand base 12 has a top and a bottom, and includes first, second, and third elongate base legs 16A, 16B, and 16C. At the top of the stand base is a support leg bracket 18.

In the embodiment illustrated in FIG. 1, each base leg has a bottom at the bottom of the support stand and correspondingly at the bottom of the stand base, and a top at, or in the vicinity of, the top of the stand base. Base leg 16A, as illustrated in FIG. 1, is straight and extends from the bottom of the stand base to the top of the stand base such that, in a stand-upright orientation, in general, base leg 16A extends vertically from the bottom of the leg to the top of the leg. Base legs 16B and 16C have lower portions 16BL, 16CL, upper portions 16BU, 16CU, and intermediate portions 16AI, 16BI, 16CI. Below intermediate portions 16BI, 16CI, the lower leg portions 16BL, 16CL are parallel to each other and parallel to base leg 16A. Base legs 16B and 16C change directions at intermediate leg portions 16BI 16CI such that the upper portions 16BU, 16CU of base legs 16B, 16C converge toward a common joinder locus 20 on base leg 16A at the upper ends of base legs 16B, 16C and toward the top of base leg 16A. Base leg 16A includes an extension portion 16AEP, which extends upwardly from joinder locus 20 to the top of the stand base at the top of support leg bracket 18.

Base legs 16A, 16B, 16C can be made of any material which is sufficiently strong, stiff, and rigid to provide the desired level of support. Examples of such materials can be selected from metals such as steel or aluminum, or from plastics such as polyethylene, polypropylene, or polyvinylidene chloride, as well as from other metals or polymers, including pultruded e.g. fiberglass-reinforced polymers. Base legs 16B and 16C can be rigidly joined to base leg 16A at the joinder locus by e.g. welding, plastic melt-bonding, clamping, pinning, or other known mechanical fastening or melt joinders. In the alternative, base legs 16B and 16C can be joined to base leg 16A by one or more pivoting joints, albeit at a fixed location on base leg 16A.

In the embodiments illustrated herein, the base legs are fabricated using ⅜ inch thick steel rod, and base legs 16B, 16C are welded to base leg 16A at joinder locus 20.

The change in directions of base legs 16B, 16C, in the case of steel rod, expresses the results of the steel rods having been subjected to a bending process, optionally two pieces of steel rod being joined at the desired angle by a welding process. Such change in direction at the intermediate loci can also be accomplished with a joint wherein the lower portion of the leg can articulate with respect to the upper portion of the leg, articulating between a limited number of pre-selected angles between the upper and lower portions of the legs.

In the embodiment illustrated in FIG. 1, below the elevation of intermediate portions 16BI, 16CI, and yet remote from the bottoms of the base legs, driver connectors 22 extend generally horizontally across the spaces defined between the respective lower, and parallel, portions of the base legs, including between respective portions of base leg 16A, and base legs 16B and 16C, at heights above the bottom of the stand corresponding to the heights of such joinder at base legs 16B and 16C. Thus, a first driver connector extends horizontally between base leg 16A and base leg 16B; a second driver connector extends horizontally between base leg 16B and base leg 16C; and a third driver connector extends horizontally between base leg 16C and base leg 16A. In FIG. 1, the second driver connector between base leg 16B and base leg 16C is shown fragmented in order to clarify that the second driver connector is not connected to, and indeed passes behind, base leg 16A, whereby base leg 16A is closer to the viewer than are base legs 16B or 16C in FIG. 1.

While three driver connectors are shown connecting the lower portions of the legs, a single driver connector, or two driver connectors, can be used.

In embodiments where the base legs are articulated at the joinder loci and at the intermediate loci, the driver connectors may also be articulated at their joinders with the base legs. In such case, a given driver connector can have an articulation joint between its joinders with respective ones of the base legs, thereby to fold as the base legs articulate about the joinder loci.

The function of driver connectors 22 is two-fold. First, driver connectors 22 are rigid, sturdy structures once unfolded, or always if such driver connectors are so designed that the driver connectors do not fold. For example, in the rigid, non-folding configuration, the driver connectors can be made with the same type of ⅜ inch steel rod used for the base legs, where the driver connectors are rigidly attached to the base legs, such as by welding where the driver connectors and base legs are steel, or melt bonding or suitable adhesive where the driver connectors and base legs are polymeric. Other methods of attachment can be used. In any event, the driver connectors, by their sturdy structures, and rigid connections in the extended configuration, serve to reinforce and preserve the spatial relationships between the respective pairs of legs at the lower portion of the stand base, much like truss webs reinforce and maintain the spatial relationships between the stringers in a truss. However, in the folding configuration, such spatial relationships can be collapsed as the driver connectors fold in combination with the base legs being articulated toward each other for a more compact structure for e.g. transportation.

Second, driver connectors 22, when fully extended, provide a convenient structure/tool for driving the legs of the support stand/stand base into natural soil. Namely, the spacing between the respective base legs is great enough that the lengths of the driver connectors are long enough, for an adult to place e.g. the full width of their shoe/boot on a respective driver connector, so as to effectively apply their body weight to the shoe/boot on the driver connector with sufficient force to drive the lower portions of the base legs into natural soil, optimally to the elevation of the driver connector, such that the full lengths of the legs, up to the driver connectors, are under the surface of the soil. However, the distance between the legs at driver connectors 22, in the fully extended configuration, is typically limited to that needed to apply a user's foot/boot. Thus, the distance between at least two of the legs, at the driver connector, is typically no more than about 20 inches, more typically no more than about 15 inches, still more typically no more than about 12 inches.

The lengths of the base legs below the driver connector are long enough that, when the base legs are driven into the soil/ground up to the heights of the driver connectors, the lengths of the base legs in the ground/soil are long enough to hold stable that portion of the tool stand which is above the soil surface, under typical weather conditions. Thus, the tool stand, when suitably installed, with the base legs driven into the soil up to e.g. the heights of the driver connectors as illustrated in FIG. 1, the stand is not subject to being blown over by common winds or other inclement weather. In typical embodiments, the driver connectors are no more than 10 inches above the bottoms of the legs, optionally 6-10 inches above the bottoms of the legs, optionally 8-10 inches above the bottoms of the legs. Such distances have been found to be generally reliable for stabilizing such tool stand having a maximum extended height of e.g. 45-55 inches above the ground when about 6 inches of the base legs is below the ground surface, and without suggesting driving the base legs to such depth that the resistance of the soil/ground becomes a substantial obstacle to driving the base legs to the heights of the driver connectors or pulling the base legs out of the ground.

In the alternative, the driver connector structure can be above the intermediate portions of the respective base legs, including above the mid-points of the legs, and extending across the upper portions of the base legs, as shown in dashed outline in FIG. 1. In the case where the driver connector extends across the upper portions of the legs, the distance between the base legs is smaller, such that a driver connector confined to the distance between the base legs may not be long enough to be easily accessed for the driving function. In such case, and as illustrated in dashed outline, the driver connector extends beyond the legs in order to be more readily accessed by the user's hands for the action of driving the base legs into the ground using the user's body weight as applied through the user's hands. Also in such case, the user uses their own judgment regarding how far the lower portions of the legs should be driven into the soil/ground to stabilize the tool stand in its installed condition. Typically, the base legs will be designed such that the tool stand is stable by the time the legs are driven into the ground/soil to the heights of the bends at the intermediate portions of the base legs.

Further as illustrated in dashed outline in FIG. 1, a single driver connector can be used where the spatial fixation of all three legs by the driver connector is not needed.

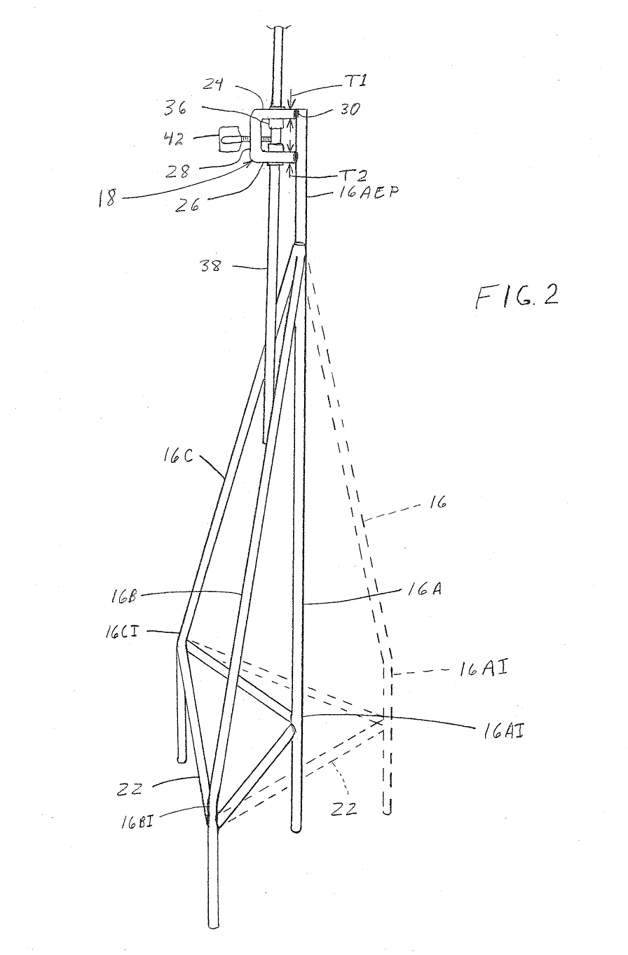

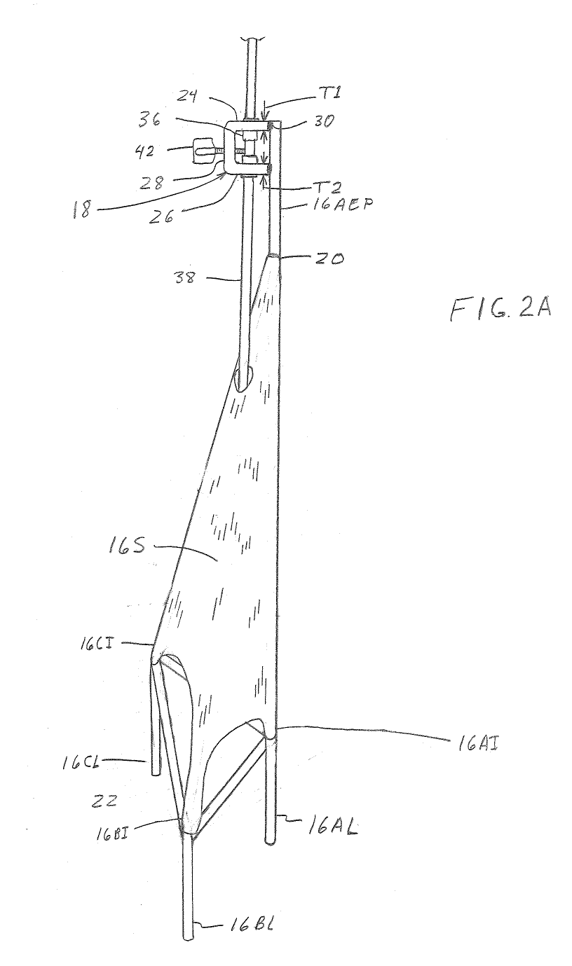

FIG. 2 clearly shows base leg 16A as straight, while base legs 16B, 16C are bent at the intermediate portions. FIG. 2 further shows base leg 16A displace in dashed outline and labeled 16, bent, such that all three legs can be bent if desired. In such case, when the support stand is in an upright, generally vertical, orientation the converging portions of all three base legs, including base leg 16A, extend at acute angles to the vertical. In such implementation, one of the base legs, such as base leg 16A, embodies a second bend at or proximate joinder locus 20 in order to provide the desired vertical presentation of the base leg extension portion of the stand base to support leg bracket 18. In the alternative, if the base leg extension portion is not vertical, bracket 18 and/or extension portion 16AEP can be modified accordingly in order to provide for a generally vertical orientation of tool support 14.

In other embodiments, only two base legs 16 are used to support the stand base. In such embodiments, both legs, including the extension portion, typically, though not necessarily, generally reside in a common plane. Both base legs can be bent/change directions, and at least one leg has a second bend above the joinder locus to provide the base leg extension portion 16AEP. Or both legs can change direction at the intermediate portions e.g. intermediate portions 16AI, 16BI and terminate at the joinder locus, and a third element extends up from the joinder locus, as the extension portion. Or one of the base legs can be straight, including extending straight upwardly from the joinder locus, as the extension portion. Or one base leg can be straight and the other base leg has a first bend at its own intermediate locus and a second bend at or proximate the joinder locus whereby that other base leg extends generally vertically upwardly as the extension portion.

In the alternative, all the legs can come together at the joinder locus, with one of the legs straight at the intermediate locus, or all the legs changing directions at the intermediate locus, and an additional structural support element is secured to the legs at the joinder locus, to serve as the base leg extension portion, in support of support leg bracket 18.

Further, more than three legs can be used. Thus, in the claims which follow, where first and second base legs, or first, second, and third base legs are recited, such recitations contemplate as well e.g. third, fourth, fifth etc. legs as optional. However, the number of legs below the driver connector(s) will typically not be greater than 6 legs.

In some embodiments, the base legs between e.g. the intermediate portions and the joinder locus can be embodied in a sheet material having an upwardly-converging-narrowing cross-section which is sufficiently structurally sturdy to support the support leg bracket 18, including all of tool support 14 and any tools mounted thereon.

Thus, it is clear that the base legs can take on a number of variations, in terms of number of legs, whether all the base legs change directions or whether one of the base legs is straight, whether one or more base legs changes direction more than once, base leg material, methods of joining the base legs to each other at the joinder locus, and reinforcement of the base leg structure using driver connectors 22. Further, at and/or above the bend/direction changes in the legs, the individual legs can be replaced by a sheet material which extends from, generally, the tops of the lower portions of the legs, toward the joinder locus, and can also replace the base leg extension portion up to support leg bracket 18. FIG. 2A shows such sheet material as 16S, replacing the base legs up to the joinder locus 20.

As illustrated collectively in FIGS. 1-3, support leg bracket 18 supports tool support 14 generally, and specifically supports tool support leg 24 from stand base 12.

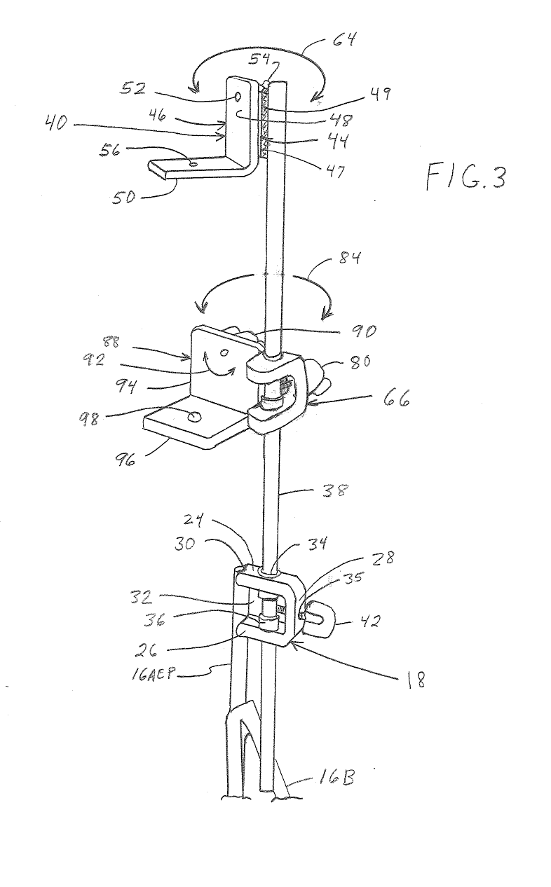

Returning to FIGS. 2 and 3, support leg bracket 18 has an upper lateral leg 24, a lower lateral leg 26, and a bight leg 28. Upper lateral leg 24 has a first remote end, remote from bight leg 28, a first proximal end adjoining bight leg 28, and a first thickness “T1”. Lower lateral leg 26 has a second remote end, remote from bight leg 28, a second proximal end adjoining bight leg 28, and a second thickness “T2”, which is typically, but not necessarily, equivalent to the thickness “T1” of lateral leg 24. Collectively as shown, upper lateral leg 24, bight leg 28, and lower lateral leg 26 define a continuous U-shaped strip of material, where the proximal ends of the lateral legs merge into the upper and lower ends of the bight leg.

While support leg bracket 18 can be joined to extension portion 16AEP of base leg 16A by any of a variety of mechanical joinder methods, in the illustrated embodiments, the lateral and bight legs of bracket 18 are steel, as is base leg 16A, and bracket 18 is joined to extension portion 16AEP by welds at the remote ends of lateral legs 24, 26. As with the base legs, the lateral and bight legs of bracket 18 can as well be made of other materials so long as those materials provide the strength, stiffness, rigidity, and the like required to support a tool which is desired to be supported by the tool stand.

In light of the above description, support leg bracket 18 is rigidly mounted to the top/extension portion of the stand base, with enough structural support between the stand base and the bracket that the bracket can provide the desired level of structural support to tool support 14.

The combination of lateral legs 24, 26 and bight leg 28 collectively define a space 32 between the respective three legs and the unbounded side of such space, which unbounded side is defined by an imaginary line (not shown) between the remote ends of lateral legs 24, 26.

Apertures 34 extend, top-to-bottom, through each of the upper and lower lateral legs, intermediate the remote and proximal ends of the respective lateral legs. Aperture 34 in the upper lateral leg is coaxial with aperture 34 in the lower lateral leg, such that the apertures 34 in the lateral legs are aligned with each other across space 32. A threaded aperture 35 extends laterally through bight leg 28 and a central axis of aperture 35 intersects the central axes of apertures 34 in the lateral legs.

Shoulder bushings 36 extend through apertures 34 in lateral legs 24, 26. A shoulder bushing 36 has an enlarged shoulder on one end thereof which prevents the bushing from being pushed entirely through the aperture. Thus, the bushing is inserted into the aperture and pushed along the length of the bushing until the shoulder impacts the leading edge of the respective lateral leg at the aperture. The shoulder structure assures that the bushing is properly longitudinally positioned in the aperture.

Bushings 36 are elongate bushings which extend entirely through the respective apertures, and extend across space 32 beyond the end of the aperture remote from the inserting aperture end by a distance approximately at least as great as the thickness “T1”, “T2” of the respective lateral leg, leaving an non-bushed portion of the distance across space 32 between the upper and lower bushings 36. As usual with bushings, the outer diameters of the bushings closely approximate the diameters of the apertures 34 into which the bushings are assembled.

In an exemplary embodiment of the support leg bracket, thicknesses “T1” and “T2” of lateral legs 24, 26 are about 4 mm, and the corresponding thickness of bight leg 28 is about 4 mm. The side walls of bushings 36 are about 1 mm thick. Bushings 36 each extend about 6 mm into space 32. The distance across space 32 between lateral legs 24 and 26, in the illustrated embodiments, is about 30 mm, and the distance across space 32 between bight leg 28 and base leg extension portion 16AEP is about 30 mm.

Tool support 14 includes a tool support leg 38 and a tool bracket 40. In the illustrated embodiments, tool support leg 38 is a steel rod having a constant diameter of about ⅜ inch along the entirety of its length. Tool support leg 38 extends through apertures 34 and bushings 36, and thus through lateral legs 24, 26 of support leg bracket 18 and across space 32, approximately midway between base leg extension portion 16AEP and bight leg 28.

Set screw 42 extends through, and engages the threads of, aperture 35 in bight leg 28 and is driven against the side of tool support leg 38. The driving of set screw 42 laterally against the side of tool support leg 38 imposes a lateral stress on tool support leg 38 sufficient to create a frictional engagement between the end of set screw 42 and the side of tool support leg 38. Choosing to not be held to theory, applicant believes that the side stress caused by set screw 42 on tool support leg 38 also causes enough bend response in tool support leg 38 in space 32 that tool support leg 38 applies lateral stresses on the inner surfaces of bushings 36, sufficient to incrementally increase the net friction between bushings 36 and tool support leg 38; with the consequence that such increased net friction between bushings 36 and tool support leg 38 provides a significant contribution to the holding power of set screw 42, holding tool support leg 38 at a “set” vertical elevation once the set screw is driven against the side of tool support leg 38.

With set screw 42 retracted, tool support leg 38 can be moved vertically up and down within tool support bracket 18 through apertures 34 and bushings 36. Once a desired elevation is achieved for the tool support leg, set screw 42 is driven/tightened against the side of tool support leg 38 in space 32, thus temporarily setting/fixing the height of the tool support leg on support stand 10. When the user desires to change the height of the tool support, thus the height of tool support leg 38, set screw 42 is withdrawn from contact with the tool support leg, thus freeing the leg to be again vertically adjusted. Such adjustment of the tool support leg allows the overall height of support stand 10 to be reduced/collapsed for transportation such as commercial shipping e.g. to a customer, transport in a vehicle to a use property, and/or for manual transport of the stand from the vehicle to an emplacement site. Similarly, once the stand is at an emplacement site, the height of the stand is readily increased by extending the tool support leg through tool support bracket 18 and again applying the set screw against the tool support leg in space 32.

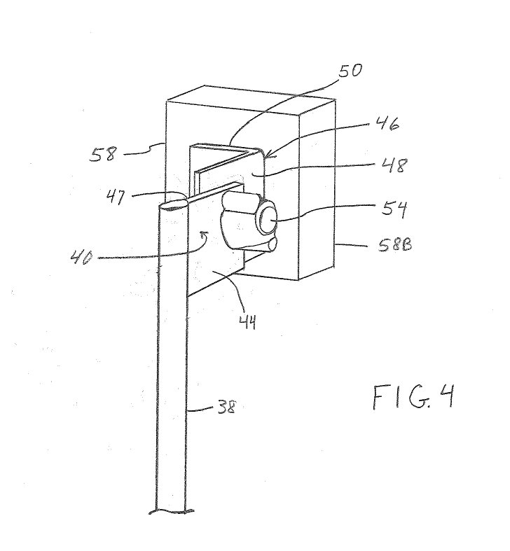

Turning now to FIGS. 3 and 4, tool bracket 40 includes a transversely extending rigid upright flange 44 and a rigid angular flange 46. Upright flange 44 is generally embodied in an uprightly oriented flat plate, e.g. a metal or hard plastic plate, extending parallel to, and transversely from tool support leg 38, such that an elongate proximal edge 47 of the flange 44 extends along the length of support leg 38, and is rigidly attached to support leg 38. Such rigid attachment may be permanent or temporary. A permanent attachment may be achieved by e.g. welding the plate to the support leg. A temporary attachment may be achieved by using a suitably-designed bracket or the like. In the illustrated embodiments, flange 44 is permanently attached to support leg 38 by a weld 49 which extends the full length of the edge of flange 44 where the flange meets the support leg.

Angular flange 46 has a first rigid plate 48 disposed in surface-to-surface relationship with a major surface of upright flange 44. A second rigid plate 50 is disposed at generally a right angle to plate 48 and extends away from upright flange 44.

A first hole (not shown) extends through upright flange 44 at a location substantially displaced from support leg 38. A second hole 52 extends through upright plate 48 as illustrated in FIG. 3. Second hole 52 is threaded. A thumb screw 54 extends through the first hole in upright flange 44 and engages the threads in hole 52 in upright plate 48, releasably mounting angular flange 46 to upright flange 44.

With support stand 10 in an upright orientation, and while thumb screw 54 is engaged in hole 52 but not tightened, angular flange 46 can be rotated about thumb screw 54, thus to select a desired angle of orientation of flange 46 relative to flange 44 and thus relative to the ground. With second plate 50 at the desired angle of orientation, thumb screw 54 can be tightened to temporarily lock flange 46, and thus the second plate 50, at the desired angle of orientation relative to upright flange 44, thus at the desired angle of orientation relative to the ground. If/when a second different angle is desired, thumb screw 54 is loosened, angular flange 46 is moved to the second different angle, and thumb screw 54 is again tightened.

A third hole 56 extends through second plate 50 at a convenient location on plate 50. With thumb screw 54 loosely mounting angular flange 46 to flange 44, flanges 44 and 46 are so positioned relative to each other and relative to support leg 38 that flange 46, when rotating about thumb screw 54, can extend freely across, and in front of, support leg 38 without being blocked by support leg 38. Accordingly, a camera 58, or other tool, can be mounted to tool bracket 40 by driving an e.g. thumb screw 60 through the third hole 56 in the second plate 50 and into the respective tool, and the camera can be freely rotated about screw 54 to a desired angular orientation, about the generally horizontal axis of screw 54 unless/until the camera or other tool, itself comes up against support leg 38. In such instance, the desired angle can still be achieved by a combination of rotating support leg 38 and flange 46.

A such camera 58 is shown in side view in FIG. 1, mounted to that surface of plate 50 which is most remote from plate 48. A first camera 58A is a bottom-mount camera wherein screw 60 extends through plate 50 and into a threaded hole in the bottom of the camera body. FIG. 1 also illustrates the end of thumb screw 54 as seen through hole 56.

FIG. 4 shows a second camera 58B mounted to the same surface of the same plate 50 at a different time. However, the second camera 58B is a rear-mount camera wherein screw 60 extends through plate 50 and into a threaded hole in the back or the camera body.

As suggested in FIGS. 1 and 4, the upward or downward direction in which the lens 62 of the camera points can be controlled by adjusting such angle when screw 54 is relatively loose. Thus, the user can adjust the up or down direction in which the camera points by loosening screw 54, rotating flange 46 relative to flange 44 and screw 54 to a desired up/down angle, and while holding that angle, tightening screw 54. The tightening of screw 54 draws flange 46 into frictional engagement with flange 44 such that flange 46, and thus the camera, is temporarily held in the fixed angular orientation relative to flange 44 until screw 54 is loosened sufficiently to release such frictional engagement.

Once the base legs of support stand 10 have been driven into the ground/soil, thereby stabilizing the stand at the selected location, the elevation of the tool/camera 58 can be changed, and the tool/camera can be oriented in any direction relative to base legs 16 by loosening set screw 42. With set screw 42 loosened, tool support leg 38 can be repositioned for elevation and angular rotation, thus raising or lowering the camera and rotating the camera to any desired angle about the vertical axis defined by the tool support leg. Once the desired elevation and angle have been achieved, set screw 42 is tightened, thereby temporarily fixing the elevation and angle of the camera relative to support leg 38.

In light of the above, a camera 58B can be pointed in any desired up/down direction by manipulation of the camera 58 and screw 54. The camera can be raised or lowered, and oriented in any direction about a vertical axis by manipulation of tool support leg 38 or any element attached to the support leg, in combination with manipulation of set screw 42 on support leg bracket 18.

Tool support stand 10 can be used as above described to support a single camera, and wherein that single camera can be positioned and oriented to point in literally any direction, at any up or down angle, and at any angle in a 360 degree radius about the stand base, at any time, including after the stand has been fixedly driven into the underlying soil/ground. Such 360 degree radius potential is indicated by double headed arrow 64 circling support leg 38 in FIG. 3. Thus the orientation of the stand base imposes no limits on the user's ability to select any direction in which to point the camera or other tool mounted to the support stand.

However, in some instances, and for some uses, it is desirable to mount a second and/or third and/or fourth, etc. camera or other tool to the same support stand, all at the same time. For example, a user may wish to simultaneously monitor activity in more than one direction, whereby it would be desirable to mount a second and/or third camera to the support stand.

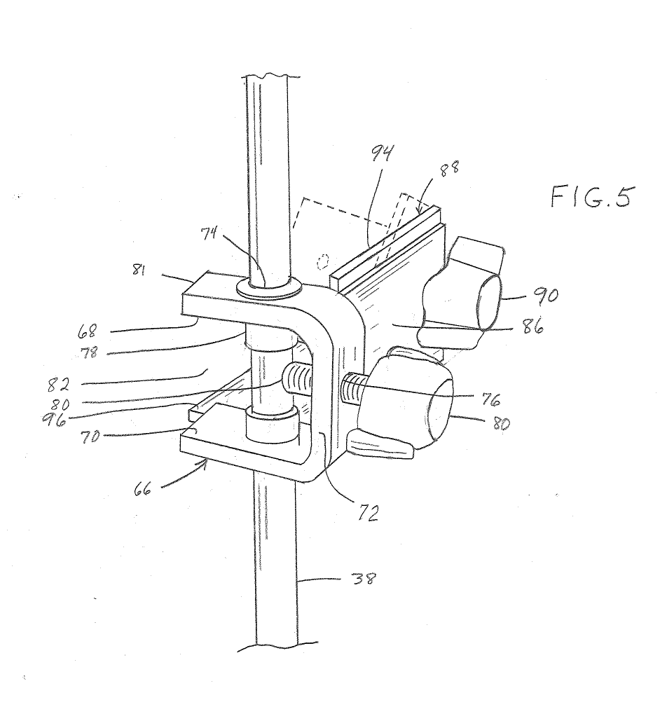

In FIGS. 3 and 5, a second tool bracket 66 has upper and lower lateral legs 68, 70, bight leg 72, apertures 74 through the lateral legs, threaded aperture 76 through bight leg 72, bushings 78 in apertures 74, and set screw 80 through aperture 76 extending across space 82 and impacting support leg 38, all generally corresponding to corresponding structures and functions in support leg bracket 18. However, the remote ends 81 of lateral legs 68, 70 are not independently mounted to anything. Rather, the stress imposed on support leg 38 by set screw 80, in combination with the apparent friction applied at bushings 78 holds second tool bracket 66 at a desired elevation on support leg 38. The elevation of bracket 66 is readily adjusted by loosening set screw 80 and moving the bracket to the desired elevation. At the same time, namely while the set screw is in its loosened condition, bracket 66 can be rotated about support leg 38 as illustrated by double headed arrow 84 in FIG. 3, in order to set bracket 66 at any desired 360 degree orientation about the axis of support leg 38. Thus, set screw 80 enables setting bracket elevation as well as bracket rotational angle relative to support leg 38.

Referring to tool bracket 40 and upright flange 44 which is fixedly attached to support leg 38 and extends transversely away from the support leg, in bracket 66 a similar upright flange 86 is fixedly attached to bight leg 72 and extends transversely away from the bight leg.

Again referring to tool bracket 40 and angular flange 46 which is mounted to upright flange 44 through a hole (not shown) by screw 54, and wherein angular flange 46 can rotate about flange 44 and screw 54 thus to set any up/down direction in which a camera can be pointed; in bracket 66, angular flange 88 is mounted to upright flange 86 through a hole (not shown) in flange 86 by screw 90 whereby angular flange 88 can rotate about flange 86 as suggested by double-headed arrow 92 in FIG. 3, thus to set any up/down direction in which a camera may desirably be pointed. Angular bracket 88 has an upright plate 94 and a second plate 96 extending at a generally perpendicular angle to plate 94 and away from upright flange 86.

A hole 98 extends through plate 96 at a convenient location. Hole 98 corresponds generally to hole 56 in plate 50 in tool bracket 40. Accordingly, as with bracket 40, a camera 58 or other tool can be mounted to tool bracket 66 by driving an e.g. thumb screw 100 through hole 98 in plate 96 and into the respective tool.

The description herein has earlier described how a first camera or other tool can be mounted to tool bracket 40 at the top of the support stand and pointed in literally any direction using rotation of the camera about bracket elements or rotation of support leg 38 about the support base. Similarly, a camera mounted to plate 96 can also, independently, be pointed in literally any direction by rotation of bracket 66 about support leg 38 using set screw 80 and can be pointed up or down by rotation of angular flange 88 about screw 90.

Thus, once the stand base is set in the ground, an upper camera can be oriented in any direction as desired, and second and/or third cameras etc. can be independently oriented in any different direction as desired.

The support stand/camera combination is generally used as follows. Typically the support stand is transported with support leg 38 retracted such that tool bracket 40 is as close to support leg bracket 18 as is practical. Namely, any second bracket 66 is first moved into proximity with support leg bracket 18, then screw 42 is loosened and support leg 38 is retracted until bracket 40 is proximate bracket 66. In some instances, support leg 38 is first extended upwardly until leg 38 is released from bracket 18 as the bottom end of leg 38 exits aperture 34 through upper lateral leg 24. Then, as desired bracket 66 may be disassembled from leg 38 by sliding bracket 66 off the bottom of leg 38 after leg 38 has been released from bracket 18. After removal of bracket 66, support leg 38 can be re-assembled to the stand base using bracket 18, or can be transported separated from the base.

However the stand elements are transported, once the user reaches the emplacement site/location, any secondary brackets 66 are first assembled to support leg 38. Then the support leg is assembled to the stand base by extending the support leg through apertures 34 in bracket 18. Screws 42 and 80 can be tightened as desired.

With the secondary brackets assembled to the support leg, with the support leg assembled to the stand base, the stand is ready for emplacement at a desired location, and use. The stand is positioned at the selected location on a natural soil surface with the lower ends of the legs pointing downwardly. The user then manually pushes downwardly on the stand, optionally on any rigid portion of the stand, driving the stand legs into the ground/soil. A convenient interface for such pushing interface is driver connectors 22. Where the driver connectors are relatively lower on the stand base, the user's foot is conveniently used for the pushing. The user simply steps on one or more driver connectors with his or her foot and applies his or her weight to the foot. The downward force of the user's weight, in most cases, drives legs 16 into the ground. Except where the ground/soil is extremely hard, or in rock, the weight of a typical adult male human is sufficient to drive the base legs sufficiently into the ground to stabilize the stand.

As an alternative, the support leg and any secondary brackets can be assembled to the stand base after the stand base has been pushed into the ground/soil.

With the base legs in the ground, with the stand stabilfzed and assembled, the one or more cameras can be mounted to plates 46, 96 if not already so mounted. Height and radial angle of bracket 40 are adjusted using set screw 42. The cameras are then pointed in the desired directions and fixed in those directions using, collectively, screws 54, 80, and 90, with optional fine tuning of the radial direction of bracket 40 using set screw 38.

With the camera or cameras so set up a first set of images is recorded. If desired the stand/cameras can then be moved to a different location. Such move typically includes removing the cameras from brackets 40 and 66, though such camera removal is not required. With the cameras removed, or not, the user pulls upwardly on the stand, pulling the base legs out of the ground.

The user then moves the stand and cameras to the second location, again positions the stand on the natural soil/ground, with the legs pointing down and again applies manual force, pushing the legs into the ground/soil. The cameras are re-mounted to the stand if not already so mounted. The user again points the cameras in desired directions, and records a second set of images while the camera is so fixedly located in the second location.

In the following claims, where base legs are recited in a particular number, such recitation optionally includes use of sheet material generally encompassing the space between the legs in place of a specific plurality of legs over at least part of the height between the intermediate portions of the legs and the joinder locus.

Although the invention has been described with respect to various embodiments, it should be realized this invention is also capable of a wide variety of further and other embodiments within the spirit and scope of the appended claims.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A tool stand, comprising:
(a) a stand base, said stand base having a top and a bottom, and a height between the top and the bottom, said stand base comprising first, second, and third elongate base legs in fixed spatial relationship to each other, said first, second, and third base legs having respective first, second, and third lower ends, respective first, second, and third upper ends, and respective first, second, and third intermediate loci between the respective upper and lower ends, said first, second, and third base legs being parallel to each other between said intermediate loci and the lower ends of said base legs, and converging toward each other above said intermediate loci; and
(b) a tool support, having a tool support top and a tool support bottom, and a tool support height between the tool support top and the tool support bottom, said tool support being adapted to be mounted to said stand base.

2. A tool stand as in claim 1, said first and second base legs joining said third base leg at first and second fixed joinder loci at one or more upper portions of said support stand, above a mid-point of the height of said stand base.

3. A tool stand as in claim 2, an extension portion of said stand base extending upwardly above said joinder loci and comprising an extension of at least one of said first, second, and third base legs.

4. A tool stand as in claim 2, an extension portion of said stand base extending upwardly above the joinder loci, said tool support comprising a tool support leg mounted to said extension portion of said stand base by a support leg bracket, said tool support leg having a top and a bottom, and being vertically adjustable by enabled sliding and releasable fixation of said tool support leg controlled through said support leg bracket.

5. A tool stand as in claim 4, said support leg bracket comprising a first laterally extending upper leg mounted to said extension portion of said stand base at a relatively upper location and having a first remote end remote from said extension portion, a second laterally extending lower leg mounted to said extension portion of said stand base at a relatively lower location and having a second remote end remote from said extension portion, and an upright bight leg remote from said extension portion and connected to both of said first and second laterally extending legs at the respective remote ends thereof, wherein said support bracket defines a generally “U”-shaped bracket having first and second lateral legs and an upright bight leg, a space defined between said first and second lateral legs and on one side by said bight leg.

6. A tool stand as in claim 5, first and second apertures extending coaxially through said first and second lateral legs intermediate said extension portion and the respective remote ends of said lateral legs, a third aperture extending through said bight leg intermediate the remote ends of said first and second lateral legs, said tool support leg extending through the first and second apertures and across the space between the first and second lateral legs, and thus being spaced from said extension portion of said stand base, a set screw threadedly extending through the third aperture and releasably securing an elevation of said extension portion relative to said stand base.

7. A tool stand as in claim 6, said first and second lateral legs having respective first and second thicknesses, further comprising first and second bushings extending through said first and second apertures between side walls of the first and second apertures and said tool support leg, and across portions of the space between the first and second apertures, each by distances at least as great as the thickness of the respective said first or second lateral leg as penetrated by the respective first and second apertures.

8. A tool stand as in claim 4, said tool support leg being laterally spaced from said first and second joinder loci, with open space between said tool support leg and said stand base.

9. A tool stand as in claim 1, each said base leg having a top and a bottom, and wherein each said base leg changes direction at least once between the respective top and the respective bottom of a given said base leg.

10. A tool stand as in claim 1 wherein each said base leg has a top and a bottom, a driver connector extending between, and being rigidly and fixedly mounted to, at least two of said base legs, and thereby providing at least one rigidly and fixedly mounted driver connector at a height of no more than 10 inches above the bottoms of the respective said base legs.

11. A tool stand as in claim 10, a first said driver connector extending between, and being mounted to, said first and second base legs, a second said driver connector extending between, and being mounted to, said second and third base legs, and a third said driver connector extending between, and being mounted to, said third and first base legs.

12. A tool stand as in claim 1 wherein said stand base has a top and a bottom, and a mid-point halfway between the top and the bottom, and a driver connector mounted to, and extending laterally from, opposing sides of said stand base above the midpoint.

13. A tool stand as in claim 4, further comprising a tool bracket mounted to said tool support leg at the top of said tool support leg.

14. A tool stand as in claim 13, said tool bracket comprising a transversely extending flange, and an angular flange releasably and rotatably mounted to said transversely extending flange.

15. A tool stand as in claim 14, further comprising a second tool bracket releasably and rotatably mounted to said tool support, adjustable vertically along the heights of said tool support between said tool bracket and said stand base.

16. A tool stand as in claim 15, said second tool support bracket being mounted for 360 degrees rotation about a vertical axis by either or both of (i) rotation of said second tool support bracket about said tool support, and (ii) rotation of said tool support about said stand base.

17. A tool stand as in claim 15, said second tool support bracket comprising mounting structure mounting said tool support bracket to said tool support, a mounting plate extending transversely from said mounting structures, and a device plate releasably and rotatably mounted to said mounting plate.

18. A tool stand as in claim 1 wherein said upper portions of at least first and second ones of said base legs, above said intermediate portions, collectively define a sheet material wrap having a convergingly narrowing cross-section extending toward said joinder locus.

19. A tool stand, comprising:
(a) a stand base, said stand base having a top and a bottom, and a height between the top and the bottom, said stand base comprising first and second base legs, said first and second base legs having respective first and second lower ends, respective first and second upper ends, and first and second intermediate loci between the respective upper and lower ends, said first and second base legs, in a use configuration, being parallel to each other between said intermediate loci and the lower ends of said base legs and converging toward each other above said intermediate loci, and being joined to each other at fixed locations on the respective said base legs in the respective upper ends thereof, a driver connector connecting said first and second base legs to each other and thereby providing at least one driver connector at a height above the bottoms of the respective said base legs; and
(b) a tool support mounted to said stand base.

20. A tool stand as in claim 19 wherein said driver connector is no more than 10 inches above the bottom of the respective said base leg, and said lower ends of said base legs are spaced from each other in such use orientation by no more than about 15 inches.

21. A tool stand as in claim 19, said first and second base legs joining each other above a mid-point of the height of said stand base, at a joinder locus.

22. A tool stand as in claim 21 wherein one of said first and second base legs is straight between the respective upper and lower ends of the respective said base leg, and wherein said stand base is limited to no more than two base legs.

23. A tool stand as in claim 21, an extension portion of said stand base extending upwardly above the joinder locus, said tool support comprising a tool support leg mounted to said extension portion of said stand base by a tool support bracket, said tool support leg being vertically adjustable by enabled sliding and releasable fixation of said tool support leg, controlled through said support leg bracket.

24. A tool stand as in claim 19, further comprising a tool bracket mounted to said tool support leg at the top of said tool support, said tool bracket comprising a transversely extending mounting plate, and an angular device plate releasably and rotatably mounted to said mounting plate.

25. A tool stand as in claim 24, further comprising a second tool bracket releasably and rotatably mounted to said tool support, said second tool bracket being adjustable vertically along the height of said tool support between said tool bracket and said stand base.

26. A tool stand, comprising:
(a) a stand base, said stand base having a top and a bottom, and a height between the top and the bottom, said stand base comprising first and second base legs, said first and second base legs having respective first and second lower ends, respective first and second upper ends, and first and second intermediate loci between the respective upper and lower ends, said first and second base legs being parallel to each other between said intermediate loci and the lower ends of said base legs and converging toward each other at converging portions thereof above said intermediate loci, and a driver connector extending between said first and second legs, and connecting said first and second base legs to each other, at locations on the converging portions of said base legs above said intermediate loci; and
(b) a tool support mounted to said stand base.
